(19) United States
(12) Patent Application Publication
(10) Pub. No.: US 2020/0175588 A1
(43) Pub. Date: Jun. 4, 2020

(54) BLOCKCHAIN-BASED PAYMENT

(71) Applicant: Alibaba Group Holding Limited, George Town (KY)

(72) Inventor: Min Li, Hangzhou (CN)

(73) Assignee: Alibaba Group Holding Limited, George Town (KY)

(21) Appl. No.: 16/785,371

(22) Filed: Feb. 7, 2020

Related U.S. Application Data
(63) Continuation of application No. PCT/CN2020/071874, filed on Jan. 14, 2020.

(30) Foreign Application Priority Data
Apr. 30, 2019 (CN) 201910361537.3

(51) Int. Cl. G06Q 40/02; H04L 9/06; G06Q 30/06

(52) U.S. Cl. CPC G06Q 40/025; H04L 9/0643; H04L 2209/56; H04L 2209/38; G06Q 30/0627

(57) ABSTRACT

The present disclosure relates to blockchain-based payments. In some aspects, a financial institution node of a blockchain network obtains target purchase data. The target purchase data includes attribute data of a target object to be purchased by a buyer using a buyer client device communicatively connected to a commerce platform node of the blockchain and identity information data of the buyer. The attribute data of the target object includes a name and price information of the target object. The identity information data is registered with a commerce platform. The financial institution node performs, based on the target purchase data, a credit check to determine whether the buyer qualifies for a loan. In response to determining that the buyer qualifies for the loan, the financial institution node transfers a loan to an account of the commerce platform.

### CROSS-REFERENCE TO RELATED APPLICATIONS

This application is a continuation of PCT Application No. PCT/CN2020/071874, filed on Jan. 14, 2020, which claims priority to Chinese Patent Application No. 201910361537.3, filed on Apr. 30, 2019, and each application is hereby incorporated by reference in its entirety.

### TECHNICAL FIELD

One or more embodiments of the present disclosure relate to the field of data processing technology, and in particular, to blockchain-based payments.

### BACKGROUND

When users purchase products or services on e-commerce platforms, they sometimes prefer to pay by credit (such as with a credit card). However, not all users have a credit card. Therefore, some users may pay out of their own bank savings account or other methods to perform direct payment. The direct payment method restricts the consumption of users and is not conducive to the construction of a credit society.

Blockchain technology, also known as distributed ledger technology, is an emerging technology in which several computing devices participate in “accounting” and jointly maintain a complete distributed database. Since blockchain technology has the characteristics of decentralization, openness and transparency, each computing device can participate in database records, and data can be quickly synchronized between computing devices, blockchain technology has been widely used in many fields.

### SUMMARY

In view of this, one or more embodiments of the present disclosure provide a blockchain-based payment method, a blockchain-based payment apparatus, a computer device, and a computer-readable storage medium.

To achieve the above objective, one or more embodiments of the present disclosure provide technical solutions as follows.

According to a first aspect of one or more embodiments of the present disclosure, a blockchain-based payment method is provided, which is applied to a blockchain network including a commerce platform node device, a financial institution node device, and a buyer client; the buyer client being communicatively connected to the commerce platform node device, and the buyer having registered identity information data with the commerce platform; and the method including: sending, by the commerce platform node device, target purchase data, wherein the target purchase data includes attribute data of a target object to be purchased by the buyer on the commerce platform and identity information data of the buyer, and the attribute data of the target object includes a name and price information of the target object; obtaining, by the financial institution node device, the target purchase data; performing, by the financial institution node device, based on the target purchase data, a credit check to determine whether the buyer qualifies for a loan, and transferring the loan to an account of the commerce platform in response to a positive determination.

According to a second aspect of one or more embodiments of the present disclosure, a blockchain-based payment method is applied, which is applied to a blockchain network including a commerce platform node device, a financial institution node device, and a buyer client; the buyer client being communicatively connected to the commerce platform node device, and the buyer having registered identity information data with the commerce platform; and the method including: obtaining, by the financial institution node device, target purchase data, wherein the target purchase data includes attribute data of a target object to be purchased by the buyer on the commerce platform and identity information data of the buyer, and the attribute data of the target object includes a name and price information of the target object; and performing, by the financial institution node device, based on the target purchase data, a credit check to determine whether the buyer qualifies for a loan, and transfer the loan to an account of the commerce platform in response to positive determination.

According to a third aspect of one or more embodiments of the present disclosure, a blockchain-based payment method is provided, which is applied to a blockchain network including a commerce platform node device, a financial institution node device, and a buyer client; the buyer client being communicatively connected to the commerce platform node device, and the buyer having registered identity information data with the commerce platform; and the method including: sending, by the commerce platform node device, target purchase data, wherein the target purchase data includes attribute data of a target object to be purchased by the buyer on the commerce platform and identity information data of the buyer, and the attribute data of the target object includes a name and price information of the target object.

According to a fourth aspect of one or more embodiments of the present disclosure, a blockchain-based payment apparatus is provided, which is applied to a blockchain network including a commerce platform node device, a financial institution node device, and a buyer client; the buyer client being communicatively connected to the commerce platform node device, and the buyer having registered identity information data with the commerce platform; the apparatus being applied in the financial institution node device, and the apparatus including: an obtaining unit configured to obtain target purchase data, wherein the target purchase data includes attribute data of a target object to be purchased by the buyer on the commerce platform and identity information data of the buyer, and the attribute data of the target object includes a name and price information of the target object; and a loan credit check unit configured to, based on the target purchase data, perform a credit check to determine whether the buyer qualifies for a loan, and transfer the loan to an account of the commerce platform in response to a positive determination.

According to a fifth aspect of one or more embodiments of the present disclosure, a blockchain-based payment apparatus is provided, which is applied to a blockchain network including a commerce platform node device, a financial institution node device, and a buyer client; the buyer client being communicatively connected to the commerce platform node device, and the buyer having registered identity information data with the commerce platform; the apparatus being applied in the commerce platform node device, and the apparatus including: a sending unit configured to send target purchase data, wherein the target purchase data includes attribute data of a target object to be purchased by the buyer on the commerce platform and identity information data of the buyer, and the attribute data of the target object includes a name and price information of the target object.

According to a sixth aspect of one or more embodiments of the present disclosure, a computer device is provided, including: a processor, and a memory having computer programs stored thereon that are executable by the processor to execute the blockchain-based payment method performed by the financial institution node device.

According to a seventh aspect of one or more embodiments of the present disclosure, a computer device is provided, including: a processor, and a memory having computer programs stored thereon that are executable by the processor to execute the blockchain-based payment method performed by the commerce platform node device.

According to an eighth aspect of one or more embodiments of the present disclosure, a computer-readable storage medium is provided, which is configured with computer programs executable by a processor to cause the processor to perform the blockchain-based payment method performed by the financial institution node device.

According to a ninth aspect of one or more embodiments of the present disclosure, a computer-readable storage medium is provided, which is configured with computer programs executable by a processor to cause the processor to perform the blockchain-based payment method performed by the commerce platform node device.

As can be seen from the above technical solutions, the blockchain-based payment method and the blockchain-based payment apparatus, the computer device, and the computer-readable storage medium provided in this disclosure, in the process of user payment, a financial institution performs credit check and loan payment based on the identity information on the user and the information of the purchased target object, thereby it can achieve the technical effect of conveniently and quickly performing credit payment.

### BRIEF DESCRIPTION OF THE DRAWINGS

FIG. 1 is a schematic flowchart illustrating a network payment method according to an embodiment provided in this disclosure;

FIG. 2 is a schematic diagram illustrating a blockchain-based payment apparatus applied to a commerce platform node device according to an embodiment provided in this disclosure;

FIG. 3 is a schematic diagram illustrating a blockchain-based payment apparatus applied to a financial institution node device according to an embodiment provided in this disclosure;

FIG. 4 is a hardware structure diagram illustrating a blockchain-based payment apparatus of an embodiment provided by this disclosure.

### DETAILED DESCRIPTION OF THE EMBODIMENTS

Embodiments will be described in detail here, examples of which are illustrated in the accompanying drawings. When the following description refers to the accompanying drawings, the same numerals in different drawings represent the same or similar elements unless otherwise indicated. The embodiments described in the following examples do not represent all embodiments consistent with one or more embodiments of the present disclosure. Rather, they are merely examples of apparatuses and methods consistent with some aspects of one or more embodiments of the present disclosure, as detailed in the appended claims.

It should be noted that, in some embodiments, the steps of the corresponding method are not necessarily performed in the order shown and described in the present disclosure. In some embodiments, the method can include more or fewer steps than described in the present disclosure. In addition, a single step described in the present disclosure can be divided into multiple steps for description in some embodiments; and multiple steps described in the present disclosure can be combined into a single step for some embodiments.

When users purchase products or services on e-commerce platforms, they sometimes prefer to pay by credit (such as with a credit card), but not all users have a credit card, therefore some users have to pay out of their own bank savings account or other methods to perform direct payment. The direct payment method restricts the consumption of users and is not conducive to the construction of a credit society.

In order to solve the problems, one or more embodiments of the present disclosure provide a network payment method, which is applied to a network system including a commerce platform server, a financial institution server, and a buyer client. The buyer client communicates with the commerce platform server, and the buyer registers identity information data with the commerce platform.

The commerce platform described in one or more embodiments in this disclosure includes a platform that provides e-commerce services for objects such as products or services. The financial institution includes institutions that can provide financial loan credit service, such as banks. The buyer client can communicate with the commerce platform server and register the identity information data of the corresponding buyer on the commerce platform, so as to facilitate the commerce platform to identify the buyer. The identity information data can include the identifier (ID) of the buyer. In some embodiments, in order to facilitate the commerce platform to verify the buyer's qualifications or help the buyer to conduct credit payment verification, the identity information data can include real-name authentication information of the buyer, such as name information such as ID card number, etc. In an embodiment, in order to further determine the identity of the buyer, the identity information data can further include biological information of the user, such as face identification information, fingerprint identification information, and the like.

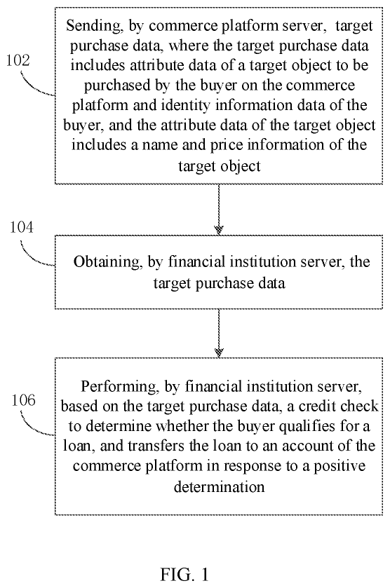

As shown in FIG. 1, the network payment method provided by some embodiments include the following steps.

At step 102, the commerce platform server sends target purchase data, where the target purchase data includes attribute data of a target object to be purchased by the buyer on the commerce platform and identity information data of the buyer, and the attribute data of the target object includes a name and price information of the target object.

The target objects described in some embodiments can include objects such as target products or target services sold on commerce platforms. When the commerce platform is a leasing commerce platform that provides leasing services for various objects, the target objects can refer to a leasing service of a target item. Those skilled in the art can expand the content range of the target objects based on some business scenario application or business scenario requirements, which are all within the protection scope defined in this disclosure.

The commerce platform server can directly send the target purchase data to the financial institution server; or it can also send the target purchase data to the financial institution server indirectly. For example, by utilizing the characteristics that each node device in the blockchain can simultaneously share the database, the target purchase data can be sent to the blockchain, so that the financial institution server can obtain the target purchase data from the blockchain's distributed database. Some embodiments of the network payment method provided in this disclosure based on a blockchain network will be described in detail in one or more embodiments below.

At step 104, the financial institution server obtains the target purchase data.

As mentioned above, based on the ways in which the commercial platform server sends the target purchase data, the financial institution server can obtain the target purchase data directly (for example, through an off-chain channel) from the commercial platform server, or can obtain the target purchase data indirectly from such as a distributed database of a blockchain.

At step 106, the financial institution server, based on the target purchase data, performs a credit check to determine whether the buyer qualifies for a loan, and transfers the loan to an account of the commerce platform in response to a positive determination.

The process performed by the financial institution server including qualification of the buyer to receive a loan can be determined according to the credit check process of the financial institution. Generally, information such as the identity of the buyer and the name and the price of the target object to be purchased will be required. In an example of credit check, the amount of loan can be determined by the price of the target object, to ensure that the amount of the loan is sufficient to cover the above target object. After a positive determination, the loan is sent to an account of the commerce platform. The above account can be an account registered by the commerce platform with the financial institution, such as the bank account of the financial institution.

In order to facilitate the buyer to complete on time the subsequent repayment operation based on the credit payment process, in some embodiments, the network payment method can further include: based on the target purchase data, determining by the financial institution server whether the buyer has opened an account with the financial institution; if not, an account opening request is presented to the buyer. The user can open a financial account with the financial institution based on the account opening request to facilitate subsequent repayment by the user.

Based on the network payment method provided by the embodiments of the present disclosure, in the process of user payment, a financial institution performs credit check and loan payment based on the identity information on the user and the information of the purchased target object. As such, it can achieve the technical effect of conveniently and quickly performing credit payment. Even if the user has not previously opened a credit account with the financial institution (or does not hold a credit card of the financial institution), the network payment method can still realize credit payment.

In the following, the present disclosure will provide one or more network payment methods based on a blockchain network. The blockchain network described in one or more embodiments of this disclosure can refer to a P2P network system with a distributed data storage structure reached by the node devices through a consensus mechanism. The data in the blockchain is distributed over “blocks” successively in terms of time, the latter block contains data summary of the previous block, and according to the consensus mechanism (such as POW, POS, DPOS, or PBFT, etc.), full data backup is achieved on all or some of the nodes. Those skilled in the art are familiar with the fact that since the blockchain network system operates under the corresponding consensus mechanism, it is difficult to tamper the data that has been included in the blockchain database by any node. For example, a blockchain applying POW consensus can have existing data be tampered under at least an attack with 51% computing power of the whole network. Therefore, the blockchain system has the characteristics of ensuring data security and anti-tampering, which cannot be matched by other centralized database systems. It can be known that the data collected in the blockchain's distributed database will not be attacked or tampered with, thereby ensuring the authenticity and reliability of the data information stored in the blockchain's distributed database.

Example types of blockchain networks can include public blockchain networks, private blockchain networks, and consortium blockchain networks. The public blockchain network is open to all entities using the P2P network and participating in the consensus process. The private blockchain network is provided to an entity that centrally controls read and write permissions. The consortium blockchain network is provided to a selected entity group (the selected entity group controls the consensus process) and includes an access control layer. The embodiments of this disclosure can be implemented in any suitable type of blockchain network.

A node (or a node device) described in one or more embodiments of this disclosure refers to a node that can join the blockchain by following a corresponding node protocol and running a node protocol program for installation. Those skilled in the art can refer to a node device that has a full backup of the blockchain distributed database as a full node, and refer to a node device that has a partial backup of the blockchain distributed database (such as data with only a block header) as light nodes. In one or more embodiments of the present disclosure, the commerce platform server and financial institution server can serve as the node devices of the blockchain. It is noted that this disclosure does not limit the node types of the commerce platform node devices or financial institution node devices.

In one or more embodiments provided in this disclosure, the buyer entity of the commerce platform joins the blockchain network by running a client installation program on a terminal, and the client installation program can be an installation program of a node device of a blockchain. Correspondingly, the client of the buyer also serves as a node device of the blockchain. The client installation program can also be a program on a blockchain user client with controlled access and connected to a consortium member node device in the consortium blockchain chain. Correspondingly, since the client does not have the authority to directly access the blockchain's distributed database, the client may not be used as a node of the blockchain, and the client can send to one or more connected consortium member node devices a request for data the client has authority to know. This disclosure does not limit whether the client of the buyer is a node device of the blockchain.

In an example of a blockchain-based payment method provided in this disclosure, the commerce platform node device can directly send the target purchase data to the financial institution node device through an off-chain channel; or can send the target purchase data to the financial institution node device through the blockchain. That is, the commerce platform node device sends the target purchase data to the blockchain, so that after the target purchase data is included in the blockchain's distributed database, the financial institution node device can obtain the target purchase data from the blockchain's distributed database.

Sending the target purchase data to the financial institution node device based on the off-chain channel can prevent the target purchase data from being obtained by a third party (without considering the malicious interception of the data), and can effectively protect the user privacy information contained in the target purchase data. Sending the target purchase data to the financial institution node device based on the distributed database on the blockchain can, with the anti-tamper mechanism of the blockchain, effectively guarantee the authenticity and accuracy of the target purchase data. In order to ensure the user privacy information contained in the target purchase data is not known to other node devices on the blockchain, the commerce platform node devices can use encryption methods known to financial institutions to encrypt the target purchase data and send it to the blockchain's distributed database. Accordingly, after obtaining the encrypted target purchase data, the financial institution can decrypt it to obtain its original text.

In some embodiments shown in this disclosure, to store the content of the target purchase data as a ledger data, for example, in an embodiment in which a commerce platform node device sends the target purchase data to the financial institution node device based on an off-chain channel. In order to further store as a ledger data the content of the target purchase data to be sent, to prevent the target purchase data from being tampered with, the blockchain-based network payment method can further include: the commerce platform node device generating a purchase transaction based on the target purchase data; and sending the purchase transaction to a blockchain's distributed database.

A transaction described in one or more embodiments in this disclosure refers to a piece of data created by a node device of a blockchain and may be finally released to a block of the blockchain. The transactions in the blockchain are classified into transactions in a narrow sense and transactions in a broad sense. A transaction in a narrow sense refers to a value transfer released by a user to the blockchain. For example, in a traditional Bitcoin blockchain network, a transaction can be a transfer initiated by a user in the blockchain. A transaction in a broad sense refers to a piece of business data with business intent released by a user entity to the blockchain through a node. The purchase ledger data storage transaction described in some embodiments can include the content of the target purchase data (original text or cipher text), or a “digital fingerprint” of the target purchase data—that is, a hash digest of the target purchase data. The anti-tampering mechanism based on the blockchain functions to store the content of the target purchase data as a ledger data.

As described above, based on the manner in which the commerce platform node device sends the target purchase data, the financial institution node device can directly obtain the target purchase data from the commerce platform node device, or obtain the target purchase data from the blockchain's distributed database. When the target purchase data is encrypted, the target purchase data should also be decrypted with corresponding decryption method to obtain its original text.

In some embodiments, after the financial institution completes the payment to the commerce platform, in order to further store the credit check and payment process as a ledger data, the blockchain-based network payment method provided by the some embodiments can also include: generating a payment transaction by the node device of the financial institution, the payment transaction including identity information data of the buyer and the amount of loan; and sending the payment transaction to the distributed database of blockchain.

The financial institution node device can generate a payment transaction, and the payment transaction includes the identity information data of the buyer, the amount of loan and other information. In some embodiments, the payment transaction can also include identity information data of the commerce platform, or attribute data of the target object. A person skilled in the art should know that the payment transaction can further include the identity information data of the buyer, the amount of loan and other information, or the identity information data of the commerce platform, or a hash digest of the attribute data of the target object and other information. Thus, the result of this credit payment is organized into a blockchain transaction to be sent to the blockchain's distributed database.

Based on the anti-tampering mechanism of the blockchain, the purchase transaction or the payment transaction described in one or more of the embodiments can be used to store ledger data for the network payment process provided in this disclosure, thereby can provide true and effective evidences for credit disputes and evidence collection.

In some embodiments, when the commerce platform node device sends the target purchase data to the blockchain, the transaction can include the target purchase data can be used as a transaction for revoking a smart contract, so that the credit check and loan payment process can be executed by a smart contract. In some embodiments, the financial institution server, based on the target purchase data, performing a credit check to determine whether the buyer qualifies for a loan, and transferring the loan to an account of the commerce platform in response to a positive determination includes: invoking the smart contract deployed on the blockchain, executing credit check logic and loan issuing logic declared in the smart contract, to, based on the target purchase data, perform a credit check to determine whether the buyer qualifies for a loan, and transfer the loan or a digital token equivalent to the loan to an account of the commerce platform in response to a positive determination.

To further provide a background to the embodiments of this disclosure, in a blockchain network, applications can be developed, tested, and deployed for execution within the blockchain network. Example applications can include, but are not limited to, smart contracts. A smart contract can be described as a digital representation of a real-world legal contract that has contract terms that affect the parties. The smart contract is implemented, stored, updated (as needed), and executed within the blockchain network. Contract parties (for example, buyers and sellers) associated with a smart contract are represented as nodes in the blockchain network.

In some examples, the smart contract can store data that can be used to record information, facts, associations, balances, and any other information needed to implement contract execution logic. A smart contract can be described as a computer-executable program consisting of functions, in which an instance of the smart contract can be created and a function invoked to execute the logic of the smart contract.

In terms of technology, smart contracts can be implemented based on objects and object-oriented classes. For example, the terms and components of a smart contract can be represented as object handled by an application that implements the smart contract. A smart contract (or an object in a smart contract) can invoke another smart contract (or an object in the same smart contract) like other object-oriented objects. For example, an invoking made by an object can be invoking creating, updating, deleting, propagating, or communicating with an object of another class. Invoking between objects can be implemented by functions, methods, application programming interfaces (APIs), or other invoking mechanisms. For example, a first object can invoke a function to create a second object.

Therefore, based on the above description of the smart contract, in some embodiments of the credit check and loan issuing process performed by the smart contract, the invoking transaction of the smart contract containing the target purchase data can also include an address of the smart contract invoked, or a function name, other parameters, and so on, which will not be elaborated herein. Those skilled in the art should know that the execution logic of this smart contract has to be verified through consensus of the node devices of the blockchain, and the tamper-resistant mechanism and consensus mechanism based on the blockchain have efficient execution (can be executed at any time by triggering a transaction), accurate execution (execution results verified by blockchain through consensus), low human intervention risk, lower operating costs (such as labor costs) and other advantages.

As mentioned earlier, the payment methods provided in this disclosure can be implemented based on a blockchain of any type or architecture. In order to meet the demand of high-frequency transaction volume and reduce the consensus delay of the blockchain, the payment method provided by the above embodiments of this disclosure can be implemented based on the consortium chain. The commerce platform node device and the financial institution node device are consortium member node devices. The buyer client is a client that is communicatively connected with the commerce platform node device. Compared with the public chain, the consensus algorithm (such as the PBFT algorithm) used by the consortium chain can be highly efficient and can meet the demand of high-frequency transaction volumes, such as frequent purchases on commercial platforms. The delay of consensus can be very low, which can meet the real-time processing requirement. It can quickly and in real time record the target purchase data or invoke and execute the smart contract in the new block of the blockchain, and record the execution result of the smart contract. Moreover, the trusted nodes in the consortium chain network (such as nodes on the commerce platform, financial institutions or government agencies) are taken as pre-selected accounting nodes, it can take into account both security and stability. In addition, the consensus algorithm of the consortium chain (such as PBFT) usually does not consume too much computing power, which can save computing resources.

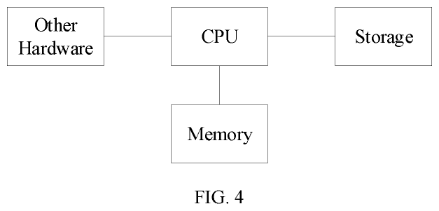

Corresponding to the embodiments of the above process, the embodiments of the present disclosure further provides a blockchain-based payment apparatus 20 and a blockchain-based payment apparatus 30. The apparatus 20 or 30 can be implemented by software, or can be implemented by hardware or a combination of software and hardware. Taking software implementation as an example, as a device in a logical sense, it is formed by reading corresponding computer program instructions into a memory through a CPU (Central Process Unit) of a device where it is located. From the hardware level, in addition to the CPU, the memory and the storage as shown in FIG. 4, the device in which the payment apparatus is located may include other hardware such as chips for wireless signal transmission and reception, and/or other hardware such as boards and cards for implementing network communication functions.

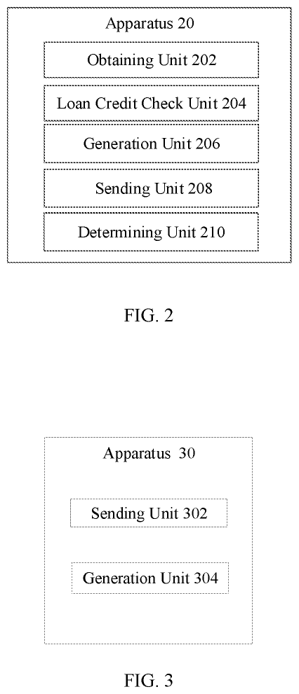

As shown in FIG. 2, this disclosure also provides a blockchain-based payment apparatus 20, which is applied to a network system including a commerce platform node device, a financial institution node device, and a buyer client. The buyer client is communicatively connected to the commerce platform node device, and the buyer has registered identity information data with the commerce platform. The apparatus 20 is applied to the financial institution node device and includes: an obtaining unit 202 configured to obtain target purchase data, where the target purchase data includes attribute data of a target object to be purchased by the buyer on the commerce platform and identity information data of the buyer, and the attribute data of the target object includes a name and price information of the target object; a loan credit check unit 204 configured to, based on the target purchase data, perform a credit check to determine whether the buyer qualifies for a loan, and transfer the loan to an account of the commerce platform in response to a positive determination.

In some embodiments, the obtaining unit 202 is further configured to obtain the target purchase data sent by the commerce platform node device through an off-chain channel.

In some embodiments, the obtaining unit 202 is further configured to obtain the target purchase data from a blockchain's distributed database, where the target purchase data was sent by the commerce platform node device to the blockchain's distributed database.

In some embodiments, the apparatus 20 further includes: a generation unit 206 configured to generate a payment transaction, where the payment transaction includes the identity information data of the buyer and an amount of the loan, or the identity information data of the buyer and a hash digest of the amount of the loan; and a sending unit 208 configured to send the payment transaction to the blockchain's distributed database.

In some embodiments, the loan credit check unit 204 is further configured to: invoke a smart contract deployed on the blockchain, execute credit check logic and loan issuing logic declared in the smart contract, to, based on the target purchase data, perform a credit check to determine whether the buyer qualifies for a loan, and transfer the loan or a digital token equivalent to the loan to the account of the commerce platform in response to a positive determination.

In some embodiment, the apparatus 20 further includes: a determining unit 210 configured to determine whether the buyer has opened an account with the financial institution based on the target purchase data; and if not, the sending unit 208 is configured to initiate an account opening request to the buyer.

In some embodiments, the blockchain is a consortium chain. The commerce platform node device and the financial institution node device are consortium member node devices. The buyer client is a user client communicatively connected with the commerce platform node device.

For the implementation process of the function and effect of each unit in the above apparatus 20, reference can be made to the implementation process of the corresponding steps in the blockchain-based payment method performed by the financial institution node device for details. For related parts, reference can be made to the description of the method embodiments, which will not be elaborated herein.

As shown in FIG. 3, this disclosure also provides a blockchain-based payment apparatus 30, which is applied to a blockchain network system including a commerce platform node device, a financial institution node device, and a buyer client. The buyer client is communicatively connected to the commerce platform node device, and the buyer has registered identity information data with the commerce platform. The apparatus 30 is applied to the commerce platform node device and includes: a sending unit 302 configured to send target purchase data, where the target purchase data includes attribute data of a target object to be purchased by the buyer on the commerce platform and identity information data of the buyer, and the attribute data of the target object includes a name and price information of the target object.

In some embodiments, the sending unit 302 is further configured to send the target purchase data to the blockchain by the commerce platform node device.

In some embodiments, the apparatus 30 further includes: a generation unit 304 configured to generate a purchase transaction based on the target purchase data; and the sending unit 302 is further configured to send the purchase transaction to a blockchain's distributed database.

For the implementation process of the function and effect of each unit in the above apparatus 30, reference can be made to the implementation process of the corresponding steps in the blockchain-based payment method performed by the commerce platform node device for details. For related parts, reference can be made to the description of the method embodiments, which will not be elaborated herein.

The apparatus examples described above are merely illustrative, wherein the units described as separate components can or cannot be physically separated, and the components displayed as units can or cannot be physical units, i.e., can be located in one place or can be distributed to multiple network modules. Some or all of the units or modules can be selected according to actual needs to achieve the objectives of solutions in the present disclosure. Those of ordinary skill in the art can understand and implement the present disclosure without any creative effort.

The apparatus, unit, or module illustrated in the above examples can be implemented specifically by using a computer chip or an entity, or by using a product having a certain function. An implementation device is a computer, and the form of the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

Corresponding to the method examples, the examples of the present disclosure also provides a computer device. As shown in FIG. 4, the computer device includes a memory and a processor. A computer program executable by the processor is stored on the memory, and the processor, when executing the stored computer program, implements the steps of the blockchain-based payment method performed by the financial institution node device in the examples of the present disclosure. For detailed description about each step of the blockchain-based payment method performed by the financial institution node device, reference can be made to the previous contents, which will not be repeated.

Corresponding to the method examples, the examples of the present disclosure also provides a computer readable storage medium having a computer program stored thereon. The computer program is executed by a processor to implement the steps of the blockchain-based payment method performed by the financial institution node device in the examples of the present disclosure. For detailed description about each step of the blockchain-based payment method performed by the financial institution node device, reference can be made to the previous contents, which will not be repeated.

Corresponding to the method examples, the examples of the present disclosure also provides a computer device. As shown in FIG. 4, the computer device includes a memory and a processor. A computer program executable by the processor is stored on the memory, and the processor, when executing the stored computer program, implements the steps of the blockchain-based payment method performed by the commerce platform node device in the examples of the present disclosure. For detailed description about each step of the blockchain-based payment method performed by the commerce platform node device, reference can be made to the previous contents, which will not be repeated.

Corresponding to the method examples, the examples of the present disclosure also provides a computer readable storage medium having a computer program stored thereon. The computer program is executed by a processor to implement the steps of the blockchain-based payment method performed by the commerce platform node device in the examples of the present disclosure. For detailed description about each step of the blockchain-based payment method performed by the commerce platform node device, reference can be made to the previous contents, which will not be repeated.

The above are some examples of the present disclosure, which are not intended to limit the disclosure. Any modification, equivalent substitution, or improvement made within the spirit and principle of the present disclosure shall be included within the protection scope of the disclosure.

In a configuration, a computing device includes one or more processors (CPUs), input/output interfaces, network interfaces, and memories.

The memories can include a non-permanent memory in a computer readable medium, a random access memory (RAM), and/or a non-volatile memory, and memories in other forms such as a read only memory (ROM) or a flash memory (flash RAM). Memory is an example of the computer readable medium.

The computer readable medium includes permanent and non-persistent, removable and non-removable media that can accomplish information storage by any method or technology. Information can be computer readable instructions, data structures, modules of a program, or other data.

Examples of the computer storage medium include, but are not limited to, a phase change memory (PRAM), a static random access memory (SRAM), a dynamic random access memory (DRAM), other types of random access memory (RAM), a read only memory (ROM), an electrically erasable programmable read only memory (EEPROM), a flash memory or other memory technologies, a compact disc read only memory (CD-ROM), a digital versatile disc (DVD) or other optical storage, a cartridge magnetic tape, a magnetic tape or disk storage or other magnetic storage devices or any other non-transmission media that can be used to store information accessible by a computing device. As defined herein, the computer readable medium does not include transitory computer readable media (transitory media) such as modulated data signals and carriers.

It should also be noted that the terms “including”, “comprising” or any other variants thereof are intended to cover non-exclusive inclusion, so that a process, method, product, or device that includes a series of elements includes not only those elements, but also other elements not explicitly listed, or those that are inherent to such process, method, product, or device. Without more restrictions, elements defined by the sentence “including a . . . ” do not exclude the existence of other identical elements in the process, method, product or device including the elements.

Those skilled in the art should understand that the examples of the present disclosure can be implemented as a method, a system, or a computer program product. Therefore, the examples of the present disclosure can take the form of an entirely hardware example, an entirely software example, or a software and hardware combined example. Moreover, the examples of the present disclosure can take the form of a computer program product implemented on one or more computer usable storage media (including but not limited to a magnetic disk storage, a CD-ROM, an optical storage, etc.) including computer usable program codes.

1. A computer-implemented blockchain-based payment method comprising:
obtaining, by a financial institution node of a blockchain network, target purchase data, wherein the target purchase data comprises (i) attribute data of a target object to be purchased by a buyer using a buyer client device communicatively connected to a commerce platform node of the blockchain and (ii) identity information data of the buyer, wherein the attribute data of the target object comprises a name and price information of the target object, and wherein the identity information data of the buyer is registered with a commerce platform;
performing, by the financial institution node, based on the target purchase data, a credit check to determine whether the buyer qualifies for a loan; and
in response to determining that the buyer qualifies for the loan, transferring, by the financial institution node, the loan to an account of the commerce platform.

2. The computer-implemented method of claim 1, wherein obtaining the target purchase data comprises obtaining, by the financial institution node, the target purchase data from the commerce platform node through an off-chain channel.

3. The computer-implemented method of claim 2, further comprising:
generating, by the financial institution node, a payment transaction, wherein the payment transaction comprises (i) the identity information data of the buyer and an amount of the loan, or (ii) the identity information data of the buyer and a hash digest of the amount of the loan; and
sending the payment transaction to the blockchain.

4. The computer-implemented method of claim 1, wherein obtaining the target purchase data comprises obtaining, by the financial institution node, the target purchase data from a distributed database of the blockchain after the target purchase data is sent by the commerce platform node to the distributed database of the blockchain.

5. The computer-implemented method of claim 1, wherein:
performing a credit check to determine whether the buyer qualifies for a loan comprises:
invoking a smart contract deployed on the blockchain; and
executing credit check logic and loan issuing logic declared in the smart contract, to, based on the target purchase data, perform the credit check; and
transferring the loan to an account of the commerce platform comprises transferring the loan or a digital token equivalent to the loan to the account of the commerce platform.

6. The computer-implemented method of claim 1, further comprising:
determining, by the financial institution node, whether the buyer has opened an account with the financial institution based on the target purchase data; and
in response to determining that the buyer has not opened an account with the financial institution, initiating an account opening request to the buyer.

7. The computer-implemented method of claim 1, wherein:
the blockchain is a consortium chain; and
the commerce platform node and the financial institution node are member node devices of the consortium chain; and
the buyer client is a user client communicatively connected with a consortium member node device in the consortium chain, wherein the buyer client requests, from the consortium member node device, data of the blockchain.

8. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
obtaining, by a financial institution node of a blockchain network, target purchase data, wherein the target purchase data comprises (i) attribute data of a target object to be purchased by a buyer using a buyer client device communicatively connected to a commerce platform node of the blockchain and (ii) identity information data of the buyer, wherein the attribute data of the target object comprises a name and price information of the target object, and wherein the identity information data of the buyer is registered with a commerce platform;
performing, by the financial institution node, based on the target purchase data, a credit check to determine whether the buyer qualifies for a loan; and
in response to determining that the buyer qualifies for the loan, transferring, by the financial institution node, the loan to an account of the commerce platform.

9. The computer-implemented system of claim 8, wherein obtaining the target purchase data comprises obtaining, by the financial institution node, the target purchase data from the commerce platform node through an off-chain channel.

10. The computer-implemented system of claim 9, wherein the operations comprise:
generating, by the financial institution node, a payment transaction, wherein the payment transaction comprises (i) the identity information data of the buyer and an amount of the loan, or (ii) the identity information data of the buyer and a hash digest of the amount of the loan; and
sending the payment transaction to the blockchain.

11. The computer-implemented system of claim 8, wherein obtaining the target purchase data comprises obtaining, by the financial institution node, the target purchase data from a distributed database of the blockchain after the target purchase data is sent by the commerce platform node to the distributed database of the blockchain.

12. The computer-implemented system of claim 8, wherein:
performing a credit check to determine whether the buyer qualifies for a loan comprises:
invoking a smart contract deployed on the blockchain; and
executing credit check logic and loan issuing logic declared in the smart contract, to, based on the target purchase data, perform the credit check; and
transferring the loan to an account of the commerce platform comprises transferring the loan or a digital token equivalent to the loan to the account of the commerce platform.

13. The computer-implemented system of claim 8, wherein the operations comprise:
determining, by the financial institution node, whether the buyer has opened an account with the financial institution based on the target purchase data; and
in response to determining that the buyer has not opened an account with the financial institution, initiating an account opening request to the buyer.

14. The computer-implemented system of claim 8, wherein:
the blockchain is a consortium chain; and
the commerce platform node and the financial institution node are member node devices of the consortium chain; and
the buyer client is a user client communicatively connected with a consortium member node device in the consortium chain, wherein the buyer client requests, from the consortium member node device, data of the blockchain.

15. A non-transitory, computer-readable medium storing one or more instructions executable by a computer system to perform operations comprising:
obtaining, by a financial institution node of a blockchain network, target purchase data, wherein the target purchase data comprises (i) attribute data of a target object to be purchased by a buyer using a buyer client device communicatively connected to a commerce platform node of the blockchain and (ii) identity information data of the buyer, wherein the attribute data of the target object comprises a name and price information of the target object, and wherein the identity information data of the buyer is registered with a commerce platform;
performing, by the financial institution node, based on the target purchase data, a credit check to determine whether the buyer qualifies for a loan; and
in response to determining that the buyer qualifies for the loan, transferring, by the financial institution node, a loan to an account of the commerce platform.

16. A computer-implemented blockchain-based payment method comprising:
sending, by a commerce platform node of a blockchain network comprising a blockchain, target purchase data, wherein the target purchase data comprises (i) attribute data of a target object to be purchased by a buyer using a buyer client device communicably connected to a commerce platform having a commerce platform node of the blockchain network and (ii) the identity information data of the buyer, and wherein the attribute data of the target object comprises a name and price information of the target object, and wherein the identity information data of the buyer client device is registered with the commerce platform;
obtaining, by a financial institution node of the blockchain network, the target purchase data;
performing, by the financial institution node, based on the target purchase data, a credit check to determine whether the buyer qualifies for a loan; and
in response to determining that the buyer qualifies for the loan, transferring, by the financial institution node, the loan to an account of the commerce platform.

17. The computer-implemented method of claim 16, wherein sending the target purchase data comprises sending, by the commerce platform node, the target purchase data to the financial institution node through an off-chain channel.

18. The computer-implemented method of claim 16, wherein:
sending the target purchase data comprises sending, by the commerce platform node, the target purchase data to the blockchain; and
obtaining the target purchase data comprises obtaining, by the financial institution node, the target purchase data from a distributed database of the blockchain.

19. The computer-implemented method of claim 18, wherein:
performing a credit check to determine whether the buyer qualifies for a loan comprises:
invoking a smart contract deployed on the blockchain; and
executing credit check logic and loan issuing logic declared in the smart contract, to, based on the target purchase data, perform the credit check, and
transferring the loan to an account of the commerce platform comprises transferring the loan or a digital token equivalent to the loan to the account of the commerce platform.

20. The computer-implemented method of claim 16, further comprising:
generating, by the commerce platform node, a purchase transaction based on the target purchase data; and
sending, by the commerce platform node, the purchase transaction to the blockchain.

21. The computer-implemented method according to claim 20, further comprising:
generating, by the financial institution node, a payment transaction comprising (i) the identity information data of the buyer and an amount of the loan, or (ii) the identity information data of the buyer and a hash digest of the amount of the loan; and
sending the payment transaction to the blockchain.

22. The computer-implemented method of claim 16, further comprising:
determining, by the financial institution node, whether the buyer has opened an account with the financial institution based on the target purchase data; and
in response to determining that the buyer has not opened an account with the financial institution, initiating an account opening request to the buyer.
